(19) United States
(12) Patent Application Publication
(10) Pub. No.: US 2008/0166290 A1
(43) Pub. Date: Jul. 10, 2008

(54) Method and Apparatus for Generating Process Heat and/or Electrical Energy

(75) Inventor: Fabian Doling, Meerbusch (DE)

Correspondence Address: Hershkovitz & Associates, LLC, 2845 Duke Street, Alexandria, VA, 22314, US

(73) Assignee: VOITH PAPER PATENT GMBH, Heidenheim (DE)

(21) Appl. No.: 10/583,732

(22) PCT Filed: Jan. 21, 2005
(86) PCT No.: PCT/EP2005/050260

§ 371 Date: Sep. 25, 2007

(30) Foreign Application Priority Data
Feb. 10, 2004 (DE) 10 2004 006 516.0

(51) Int. Cl. C01B 3/38; C10K 3/00; C01B 3/48; D21F 11/00; D21F 5/00; C01B 3/58; H01M 8/06

(52) U.S. Cl. 423/650; 423/418.2; 423/651; 423/655; 162/206; 429/13

(57) ABSTRACT

A method and apparatus for generating process heat and/or electrical energy for a machine used in the production and/or finishing of a web of fibrous material are provided. The fibrous material can be a paper web or paperboard web, and gas having a highest possible proportion of hydrogen is generated from the waste products resulting during the production and/or finishing of the web of fibrous material. This hydrogen-rich gas is used for generating the necessary process heat and/or the necessary electrical energy.

This invention relates to a method for generating process heat and/or electrical energy for a machine for the production and/or finishing of a fibrous web, particularly a paper web or paperboard web.

The process heat for paper machines was produced hitherto by combustion of fossil fuels or waste products. The electrical energy for paper machines was produced in distant power stations.

The object of the present invention is to create an improved method of the type initially referred to. In particular the use of renewable energies and/or alternative fuels should also be possible.

This object is accomplished in accordance with the invention in that gas with the highest possible proportion of hydrogen is generated from the waste products resulting during the production and/or finishing of the fibrous web, and this hydrogen-rich gas is used for generating the necessary process heat and/or the necessary electrical energy.

By virtue of this aspect of the invention, in particular renewable energies and/or alternative fuels can be used as well, in which case particularly the waste products from the machine contributing to or the paper machine involved in the production and/or finishing of a fibrous web can be put to sensible use. Furthermore, a decentralized generation of energy is now also possible.

Particularly bark, fibers, edge cuttings and/or the like can be used as waste products.

The waste products used can also be transformed into methanol first. Alternatively or in addition to this, the use particularly of a so-called DMFC (Direct Methanol Fuel Cell) is also conceivable.

According to a preferred practical aspect of the method according to the invention the waste products used are first conveyed to a reformer. In this case the hydrogen carbons of the waste products used can be transformed into a hydrogen-rich and carbon monoxide-rich gas by means of the reformer, for example through autothermic reforming, partial oxidation or vapor reforming.

To transform the carbon monoxide into another hydrogen-rich gas, the reformer can be followed by one or more shift stages.

It is also an advantage particularly if the reformer or the shift stage is followed by at least one more process stage for further reduction of the carbon monoxide.

According to an expedient practical embodiment the reformer is followed by a stage for pressure swing adsorption. Alternatively or in addition to this, the reformer can also be followed, for example, by a stage for selective oxidation as a further process stage.

Should the waste products resulting during the production and/or finishing of the fibrous web not be sufficient to meet the energy requirement, additional hydrogen carbons and/or additional H₂ can be fed to the reformer. In this case it is conceivable, for example, to supply additional hydrogen carbons in the form of natural gas, biomass, wood chips and/or the like. If H₂ is available, meaning if there is an H₂ grid for example, particularly H₂ can be supplied in addition as already mentioned.

The process heat and/or electrical energy is preferably generated in each case at that point of the machine at which it is required. In other words, the process heat and/or the electrical energy can be generated in each case on, in or near the particular unit of the machine which is to be heated or supplied with electrical energy.

It is an advantage for the process heat and/or electrical energy to be generated by a fuel cell from the acquired hydrogen-rich gas and/or from additional hydrogen taken from a grid or tank for example. It is preferred for the process heat to be generated by preferably combusting the acquired hydrogen or methanol and/or additional hydrogen taken from a grid or tank for example.

The invention will be described in more detail in the following text using exemplary embodiments and with reference to the drawing, in which:

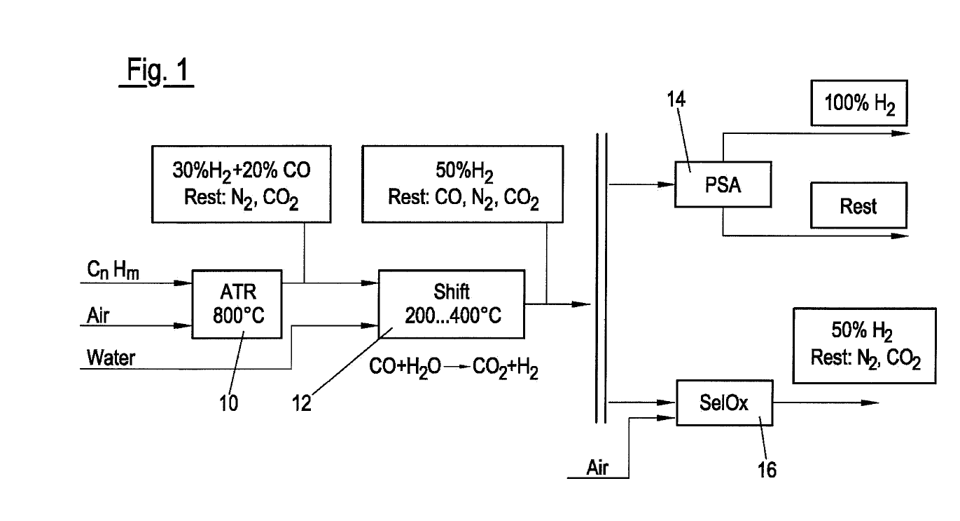

FIG. 1 is a chart of the transformation of biomass (hydrogen carbons) into hydrogen (H₂) and

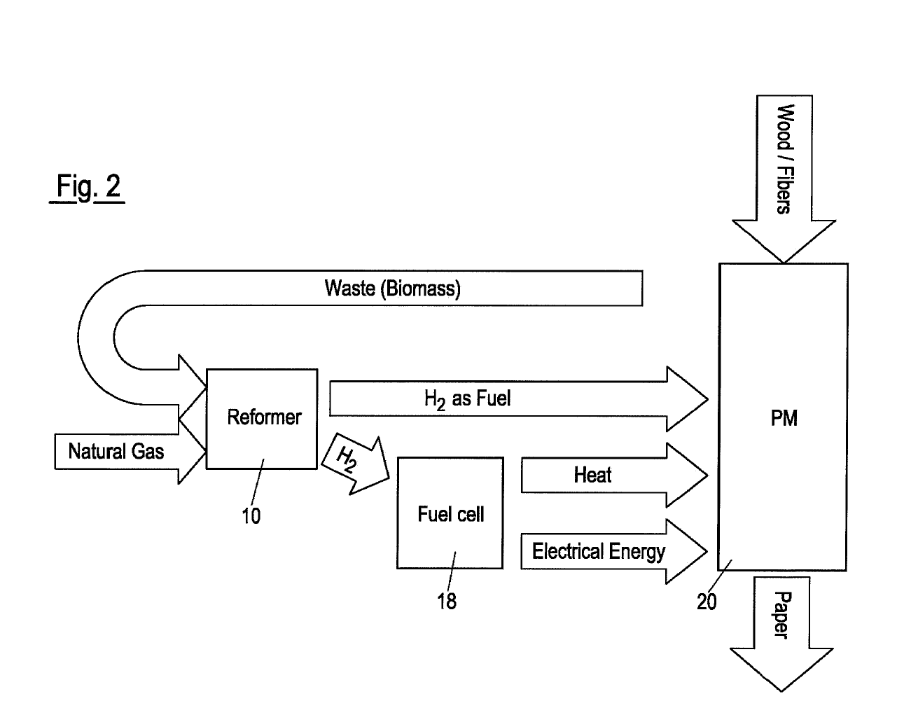

FIG. 2 is a process chart of the generation of process heat and/or electrical energy for a machine for the production and/or finishing of a fibrous web.

An advantageous embodiment of the method according to the invention for the generation of process heat and/or electrical energy for a machine for the production and/or finishing of a fibrous web, particularly a paper web or paperboard web, is described in the following text with reference to FIGS. 1 and 2 purely by way of example. Hence the machine in question can be, for example, a paper machine including an upstream stock preparation section and any units for finishing the fibrous web or paper web.

To begin with, gas with the highest possible proportion of hydrogen is generated from the waste products resulting during the production and/or finishing of the fibrous web. This hydrogen-rich gas is then used to generate the necessary process heat and/or the necessary electrical energy.

The waste materials can be, for example, bark, fibers of no use for the subsequent production process, edge cuttings and/or the like, meaning biomass or hydrogen carbons in the general sense. Apart from biomass, particularly the use of natural gas, alcohols and/or the like is conceivable.

The waste products used can also be transformed into methanol first.

FIG. 2 shows a chart of the transformation of biomass (hydrogen carbons) into hydrogen (H₂), whereby apart from biomass the use of, for example, natural gas, alcohols and/or the like is also possible.

As is evident in the diagram in FIG. 2, biomass or the waste products used can be fed first to a reformer 10. By means of this reformer 10 the hydrogen carbons concerned (CₙHₘ) are transformed into a hydrogen-rich gas and a carbon monoxide-rich gas. For this purpose, air as well as the hydrogen carbons CₙHₘ are fed to the reformer 10. In the case of autothermic reforming and vapor reforming, water is supplied in addition. In the case of partial oxidation, only air is supplied. Through the upstream operation of the reformer 10 the respective energy carrier (e.g. biomass) can be transformed by combustion into hydrogen or a hydrogen-rich gas. In the case under consideration, for example, this takes place at a temperature of around 800° C.

The hydrogen carbons CₙHₘ of the biomass or waste products used can be transformed into a hydrogen-rich and carbon monoxide-rich gas by means of the reformer 10, for example through autothermic reforming, partial oxidation or vapor reforming. To transform the carbon monoxide into another hydrogen-rich gas, the reformer 10 can be followed by a shift stage 12.

In the case under consideration there follows, for example, a vapor reforming stage in which hydrogen is obtained from hydrogen carbons CₙHₘ in two steps. In the first step the hydrogen carbon CₙHₘ is first transformed in the reformer 10 into a hydrogen-rich gas and a carbon monoxide-rich gas. The resulting carbon monoxide (CO) is then separated off and mixed in the second step, i.e. in shift stage 12, with water or steam to create another hydrogen fraction. The applicable reaction equation is as follows:

CO+H₂O→CO₂+H₂.

H₂ and CO are not separated therefore. CO and H₂O react “selectively” with each other.

The reformer 10 or the shift stage 12 can be followed by at least one more process stage for further reduction of the carbon monoxide.

In this case the reformer 10 or the shift stage 12 can be followed, for example, by a stage 14 for pressure swing adsorption and/or a stage 16 for selective oxidation as a further process stage.

The stage for pressure swing adsorption (PSA) can comprise in particular the following steps:
adsorption at high pressure
pressure decrease
flushing with product gas at low pressure
pressure increase with untreated gas or product gas

In the case of selective CO oxidation (stage 16) the carbon monoxide can be oxidized selectively to CO₂ through the supply of oxygen or air and the help of a catalyst. The hydrogen content of the synthesis gas is at least largely retained thereby.

Should the waste products resulting during the production and/or finishing of the fibrous web not be sufficient to meet the energy requirement, additional hydrogen carbons can be supplied to the reformer 10. In this case these additional hydrogen carbons can be supplied to the reformer 10 in the form of, for example, natural gas, biomass, wood chips and/or the like.

The process heat and/or electrical energy is preferably generated in each case at that point of the machine at which it is required. In other words, the process heat and/or the electrical energy can be generated in each case on, in or near the particular unit of the machine which is to be heated or supplied with electrical energy.

As is evident in FIG. 2, the process heat and/or electrical energy can be generated in particular by means of at least one fuel cell 18 from the acquired hydrogen-rich gas. Hence the process heat is preferably generated by combustion of the acquired hydrogen or methanol.

FIG. 2 shows a process chart of the generation of process heat or electrical energy for a paper machine 20 which is fed with wood, fibers and/or the like and delivers the paper 10.

As is again evident in this process chart, the waste or biomass resulting in the paper machine 20 is fed to a reformer 10. In the case under consideration, this reformer 10 is fed in addition with natural gas

The hydrogen H₂ acquired via the reformer 10 is fed on the one hand directly to the paper machine 20 as fuel. On the other hand, hydrogen H₂ generated by the reformer 10 is fed to at least one fuel cell 18, which in the case under consideration delivers both process heat and electrical energy for the paper machine 20.

### LIST OF REFERENCE NUMERALS

10 Reformer
12 Shift stage
14 Stage for pressure swing adsorption
16 Stage for selective oxidation
18 Fuel cell
20 Paper machine

1-17. (canceled)

18. A method for generating at least one of process heat and electrical energy for a machine for at least one of production and finishing of a fibrous web, comprising:
generating from waste products resulting during the at least one of production and finishing of a fibrous web a hydrogen-rich gas having a highest possible proportion of hydrogen; and
utilizing the hydrogen-rich gas for generating the at least one of process heat and electrical energy.

19. The method according to claim 18, wherein at least one of bark, fibers, and edge cuttings are utilized as waste products.

20. The method according to claim 18, further comprising utilizing at least one of:
i) the waste products which are first transformed into methanol; and
ii) a DMFC (Direct Methanol Fuel Cell).

21. The method according to claim 18, further comprising first feeding the waste products utilized to a reformer.

22. The method according to claim 21, further comprising transforming hydrogen carbons of the waste products utilized into a hydrogen-rich and a carbon monoxide-rich gas by the reformer through one of, autothermic reforming, partial oxidation, and vapor reforming.

23. The method according to claim 21, wherein the reformer is followed by a shift stage for transforming carbon monoxide into another hydrogen-rich gas.

24. The method according to claim 23, wherein one of the reformer or the shift stage is followed by at least one more process stage for further reduction of carbon monoxide.

25. The method according to claim 24, wherein the reformer is followed by a shift stage for pressure swing adsorption as a further process stage.

26. The method according to claim 24, wherein the reformer is followed by a shift stage for selective oxidation as a further process stage.

27. The method according to claim 18, further comprising feeding to a reformer at least one of additional hydrogen carbons and additional H₂ when the waste products resulting during at least one of production and finishing of the fibrous web are insufficient to meet an energy requirement.

28. The method according to claim 27, further comprising supplying the additional hydrogen carbons to the reformer in the form of at least one of natural gas, biomass, and wood chips.

29. The method according to claim 18, further comprising generating the at least one of process heat and electrical energy at a point of the machine at which the at least one of the process heat and electrical energy is required.

30. The method according to claim 29, further comprising generating the at least one of process heat and electrical energy at least one of on, in or near a particular unit of the machine which is to be one of heated and supplied with electrical energy.

31. The method according to claim 18, further comprising generating the least one of process heat and electrical energy by at least one fuel cell from at least one of an acquired hydrogen-rich gas and additional hydrogen taken from at least one of a grid or tank.

32. The method according to claim 18, further comprising generating the process heat by combusting at least one of an acquired hydrogen, methanol and additional hydrogen taken from at least one of a grid and tank.

33. The method of claim 18, wherein the fibrous web is one of paper web and paperboard web.

34. An apparatus for generating at least one of process heat and electrical energy for a machine for at least one of production and finishing of a fibrous web, wherein the apparatus is configured to provide a hydrogen-rich gas having a highest possible proportion of hydrogen generated from waste products resulting during at least one of the production and finishing of the fibrous web, and the apparatus is configured to utilize the hydrogen-rich gas for generating at least one of the process heat and electrical energy.

35. The apparatus of claim 34, wherein the fibrous web is one of paper web and paperboard web and the machine is configured for at least one of the production and finishing of the one of paper web and paperboard web.

36. The apparatus of claim 34, wherein at least one of bark, fibers, and edge cuttings are utilized as waste products and the apparatus is configured to provide the hydrogen-rich gas generated from at least one of the bark, fibers, and edge cuttings.

37. The apparatus of claim 34, wherein at least one of:
i) the waste products utilized are first transformed into methanol, and
ii) a DMFC (Direct Methanol Fuel Cell) is utilized, and the apparatus is configured to utilize at least one of the methanol and DMFC.

38. The apparatus of claim 34, wherein the apparatus comprises a reformer and the reformer is configured to be first fed with the waste products.

39. The apparatus of claim 38, wherein the reformer is configured to transform hydrogen carbons of the waste products into a hydrogen-rich and a carbon monoxide-rich gas through one of, autothermic reforming, partial oxidation, and vapor reforming.

40. The apparatus of claim 38, wherein the apparatus comprises a shift stage for transforming carbon monoxide into another hydrogen-rich gas and is followed by the reformer.

41. The apparatus of claim 38, wherein the apparatus comprises at least one more process stage for further reduction of carbon monoxide and follows one of the reformer or a shift stage.

42. The apparatus of claim 41, wherein the reformer is followed by the shift stage for one of, (a) pressure swing adsorption and (b) selective oxidation, as a further process stage.

43. The apparatus of claim 34, wherein the apparatus is configured to feed at least one of additional hydrogen carbons and additional H₂ to a reformer when the waste products resulting during at least one of the production and finishing of the fibrous web are insufficient to meet an energy requirement.

44. The apparatus of claim 43, wherein the reformer is configured to be supplied with additional hydrogen carbons in the form of at least one of natural gas, biomass, and wood chips.

45. The apparatus of claim 34, wherein the apparatus is configured to generate the at least one of process heat and electrical energy at a point of the machine at which the at least one of the process heat and electrical energy is required.

46. The apparatus of claim 45, wherein the apparatus is configured to generate the at least one of process heat and electrical energy at least one of on, in or near a particular unit of the machine that is to be one of heated or supplied with electrical energy.

47. The apparatus of claim 34, wherein the apparatus comprises at least one fuel cell and is configured to generate the at least one of process heat and electrical energy by at least one fuel cell from at least one of an acquired hydrogen-rich gas and additional hydrogen taken from at least one of a grid or tank.

48. The apparatus of claim 34, wherein the apparatus is configured to generate the process heat by combusting at least one of an acquired hydrogen, methanol and additional hydrogen taken from at least one of a grid and tank.

49. A method for generating at least one of process heat and electrical energy for a machine for at least one of production and finishing of a fibrous web, comprising: generating a hydrogen-rich gas having a highest possible proportion of hydrogen from waste products resulting during the at least one of production and finishing of a fibrous web, the hydrogen-rich gas being utilized for generating at least one of a necessary process heat and a necessary electrical energy, and hydrogen carbons of the waste products utilized being transformed into a hydrogen-rich and a carbon monoxide-rich gas by a reformer through at least one of autothermic reforming, partial oxidation, and vapor reforming.

50. An apparatus for generating at least one of process heat and electrical energy for a machine for at least one of production and finishing of a fibrous web, wherein
the apparatus is configured to provide a hydrogen-rich gas having a highest possible proportion of hydrogen generated from waste products resulting during the at least one of production and finishing of a fibrous web,
the apparatus is configured to utilize the hydrogen-rich gas for generating at least one of a necessary process heat and a necessary electrical energy,
the apparatus comprises a reformer and the reformer is configured to be first fed with the waste products, and
the reformer is configured to transform hydrogen carbons of the waste products into a hydrogen-rich and a carbon monoxide-rich gas through at least one of autothermic reforming, partial oxidation, and vapor reforming.
